(19) United States
(12) Patent Application Publication
(10) Pub. No.: US 2005/0226491 A1
(43) Pub. Date: Oct. 13, 2005

(54) Device for recognising containers

(76) Inventor: Andreas Nordbryhn, Oslo (NO)

Correspondence Address: RODMAN RODMAN, 7 SOUTH BROADWAY, WHITE PLAINS, NY, 10601, US

(21) Appl. No.: 10/519,184

(22) PCT Filed: Jun. 25, 2003
(86) PCT No.: PCT/NO03/00213

§ 371 Date: Dec. 21, 2004

(30) Foreign Application Priority Data
Jun. 26, 2002 (NO) 20023091

(51) Int. Cl. G06K 9/00

(52) U.S. Cl. 382/142

(57) ABSTRACT

A device for recognising a container, such as a bottle or a can, comprising a camera and light emission means (1, 2) arranged for imaging a selected portion of the container (3). This means is connected to a processor or the like adapted for recognition, based on a camera-recorded image, of special features related to the container. To be able to use a standard type camera with limited resolution, the imaging of the container is carried out via an assembly of mirror faces (5, 6, 7, 8), which in pairs are arranged relative to one another in such manner that two areas along the longitudinal direction of the container (3) are imaged simultaneously by the camera (1). The mirror faces in respective pairs face each other and are positioned on the same side of the optical axis of the camera (1), with one of the mirror faces (5, 7) adjacent to the optical axis, and during the imaging process the camera is directed towards the mirror faces adjacent to the optical axis, in which the two areas of the container are shown as a respective mirror image in the respective mirror face.

The present invention relates to a device for recognising a container, such as a bottle or a can, and in particular to a device for recognising distinctive features related to the container by imaging a relatively elongate and narrow area of the container.

In the field of reverse vending machines for beverage containers there are many different types of machines wherein container recognition is based on using the shape, bar code and material of the container, by either isolated or combined recognition of the respective distinctive features associated with the container. Furthermore, U.S. Pat. No. 5,593,017 discloses that container recognition can be performed by a camera and light emission means which images a marking provided on the container in the form of an embossment, for example. This particular means is connected to a processor and positioned in such manner that it faces the marking during the imaging process. The processor is equipped with the components necessary for recognition of the container by using this camera-recorded image.

However, recognition based on a camera-recorded image requires the use of a high-resolution camera. This is because the image of the container, and in particular its bar code, must have a high image quality in order to be used during the recognition procedure in the processor. The fact that the image should, as in the recognition of, for example, a bar code, cover a relative elongate and narrow area of the container, also contributes to the increased need for high resolution. The last-mentioned factor involving the imaging of such elongate and narrow areas also differs greatly from the length/breadth ratio in a standard type camera.

Accordingly, the object of the present invention is to provide a device of the type mentioned above which unlike the previously known devices can use a standard type camera that has limited resolution, and which can easily be converted from, for instance, a 500×500 element camera to a 1000×250 element camera. The use of such a standard type camera gives, among other things, a reduction in production costs and in the need for a calculating capacity in the processor.

According to the present invention, this object is achieved by means of a device for recognising a container, such as a bottle or can, comprising a camera and light emission means arranged for imaging a selected portion of the container, wherein the camera and light emission means is connected to a processor or the like adapted for recognition, based on a camera-recorded image of the marking, of distinctive features related to the container, characterised in that the imaging of the container is carried out via an assembly of minor faces which in pairs are positioned in such manner relative to each other that two areas along the longitudinal direction of the container, optionally including one or both end faces, are imaged simultaneously by the camera, wherein the mirror faces in respective pairs face each other and are located on the same side of the optical axis of the camera, with one of the mirror faces adjacent to the optical axis, and that during the imaging process the camera is directed towards the mirror faces adjacent to the optical axis, in which the two areas of the container are shown as respective mirror images in the respective mirror face.

Other advantageous features of the present invention will be apparent from the dependent claims and the description.

The invention will now be explained in more detail with reference to an exemplary embodiment shown in the attached drawings.

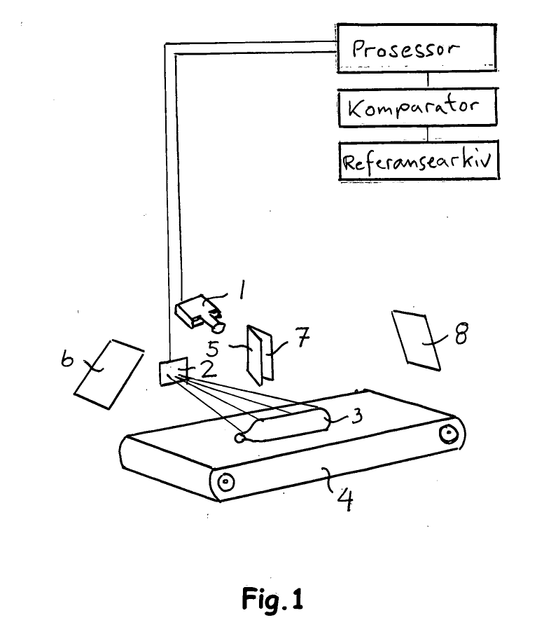

FIG. 1 is a schematic perspective view of an embodiment of the present invention used in connection with a reverse vending machine for beverage containers, in which the imaging of the container is carried out by using an assembly of mirror faces which in pairs are positioned relative to each other in such manner that two areas along the longitudinal direction of the container are imaged simultaneously by the same camera, the mirror faces in respective pairs facing each other and being positioned on the same side of the optical axis of the camera, with one of the mirror faces adjacent to the optical axis.

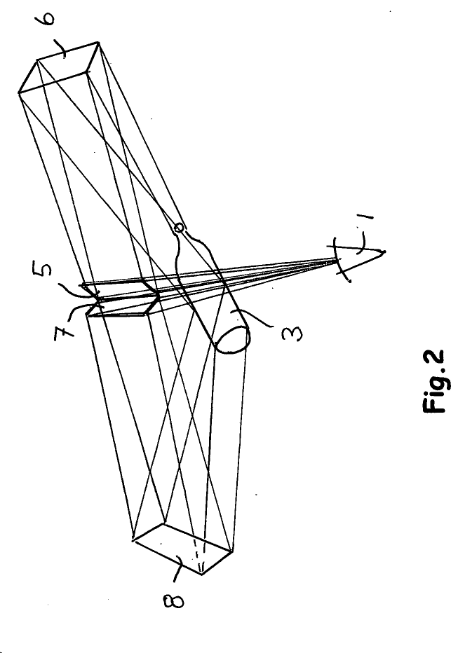

FIG. 2 shows in a simplified manner in a schematic illustration, seen in the direction of the mirror faces adjacent to the optical axis of the camera, how the camera “sees” the two areas with the aid of the pairs of mirror faces.

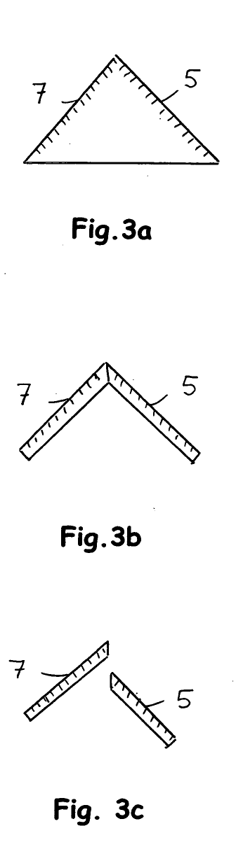

FIGS. 3a-c show a cross section of different embodiments of the mirror faces adjacent to the optical axis of the camera.

Although in the discussion of the drawings it is mentioned that the present device is a part of a reverse vending machine for beverage containers, it should be noted that the invention is not limited to either reverse vending machines or to beverage containers. Consequently, the device according to the invention could be included in a structure, e.g., a sorting plant, where it is appropriate to recognise containers based on camera-recorded images of the marking thereon. Similarly, the containers may be filled with or have contained any suitable medium.

Moreover, it should be noted that known reverse vending machines may be constructed in different ways depending upon the specifications regarding their operation. For the sake of simplicity, FIG. 1 therefore shows only the components that are necessary for the understanding of the invention, i.e., the camera and light emission means, the mirror assembly, the associated processor with comparator and reference archive, and the conveyor of the reverse vending machine. The present device for recognising containers may thus constitute a supplementary element in a reverse vending machine which, for example, has conventional equipment for recognition by means of the shape, bar code and material of the container. However, such conventional recognition equipment could also in some cases be replaced by the device according to the invention, thereby giving the reverse vending machine a much simpler structure.

The conveyor that is illustrated schematically in the drawing is of any type used in such reverse vending machines, for example, of the type able to rotate the container about its longitudinal axis into the right position relative to the equipment for recognition of the bar code etc. In that case, the conveyor may consist of two conveyor belts so positioned that they form a V-shape in cross section, and which are drawn apart to bring the container into contact with subjacent rollers for rotation about its longitudinal axis.

The schematically illustrated processor is of any commonly used type. Furthermore, the processor is adapted to control the operation of the camera and light emission means, so that, for instance, the light emission can be synchronised with the exposure of the camera, and preferably comprises a comparator and a reference archive. During the container recognition procedure, the processor chooses whether the comparator is to compare the whole of or only selected parts of the image along the longitudinal direction of the container with the reference archive, so that distinctive features related to the container can thus be recognised.

The present device comprises a camera and light emission means 1, 2 arranged for imaging the container 3 along its longitudinal direction over a relatively elongate and narrow area. The container is in the form of either a can or a bottle, usually of relatively long length. The camera and light emission means is connected to a processor or the like which, based on the camera-recorded image, is able to recognise distinctive features related to the container. Moreover, the means is so positioned that when the container is on a conveyor 4, the optical axis of the camera lens is directed essentially towards a longitudinal vertical plane through the conveyor. To provide the desired image of the container there is used according to the present invention an assembly of mirror faces 5, 6, 7, 8 which in pairs are positioned relative to each other in such manner that two areas along the longitudinal direction of the container 3 can be imaged simultaneously by the camera 1. Furthermore, the mirror faces in respective pairs face each other, as shown in FIG. 1, and are positioned on the same side of the optical axis of the camera 1, with one of the mirror faces 5, 7 adjacent to the optical axis. The two mirror images of the container which appear on the respective mirror faces adjacent to the optical axis consequently constitute the two simultaneous images from the camera

The size of the areas that are to be imaged, and their location on the container 3 can be determined by the interpositioning of the mirror faces in respective pairs. Although FIG. 2 shows imaging only along the side face of the container, it will be appreciated that one or both end faces can also be included in the imaging, if desirable. Otherwise, the size of the mirror faces in respective pairs depends upon the distance to the camera, and must be chosen so that the whole field of view is covered. Furthermore, the mirror faces 5, 7 adjacent to the optical axis of the camera are arranged symmetrically and face in opposite directions to each other.

The line of intersection between the mirror faces 5, 7 adjacent to the optical axis of the camera is essentially at right angles to the optical axis. However, this is not a condition for the mirror faces as such, as they can be arranged as desired relative to the optical axis. As already mentioned, the angular position of the mirror faces relative to each other in respective pairs determines which areas of the container are chosen for simultaneous imaging by the camera 1. Otherwise, the illustrated arrangement with the mirror surfaces adjacent to the optical axis of the camera above the container is not a condition as these mirror faces can, as required, be placed in a desired position around the longitudinal axis of the container. It will also be understood that there may be a departure from the symmetrical arrangement of the mirror faces in respective pairs relative to the optical axis of the camera.

Preferred embodiments of the mirror faces 5, 7 adjacent to the optical axis of the camera are shown in FIGS. 3a-c. Thus, these mirror faces may consist of a triangular prism body, of which the two sides facing the camera are mirror-coated, or of two square, mirror-coated plates. In the last-mentioned case, the side edge of the plates adjacent to the optical axis is bevelled, and is either positioned so that the two bevelled side edges meet or has the plates offset relative to each other along the optical axis. With an embodiment of the mirror faces adjacent to the optical axis as shown in FIGS. 3a-b, the centre point of the mirror faces will lie essentially along a straight line. However, in the embodiment shown in FIG. 3c, the centre point of the mirror faces in the respective pairs will lie along respective straight lines that are parallel to each other.

As shown in FIG. 1, the emission of light can be effected using a single light source 2 that covers the whole image area of the container 3. However, it will be appreciated that more light sources could be used, for instance light sources of different light intensity, and that the positioning may differ from that shown. The light is of any suitable type, preferably short-pulsed light, and respective light sources may consist of at least one light-emitting diode. It should also be added that the camera mentioned above is of any type within this field, for example, a CCD camera which is highly is suitable for use with short-pulsed light.

1. A device for recognising a container, such as a bottle or a can, comprising a camera and light emission means (1, 2) arranged for imaging a selected portion of the container (3), said camera and light emission means being connected to a processor or the like adapted for recognition, based on a camera-recorded image, of special features related to the container, characterised in that
said imaging is effected by at least a first pair (5, 6) and a second pair (7, 8) of mirrors, where the mirrors in each pair are facing one another and where the pairs are positioned on opposite sides of the optical axis of said camera (1), one mirror (5) of the first pair being fixedly positioned adjacent to one mirror (7) of the second pair, at an angle to said axis,
whereby said selected portions are shown as respective mirror images in the respective mirror (5, 7) and two areas along the longitudinal direction of the container (3), optionally including one or both end faces, are imaged simultaneously by the camera (1).

2. A device according to claim 1, characterised in that the line of intersection between the mirror faces (5, 7) adjacent to the optical axis of the camera is essentially perpendicular to the optical axis, these mirror faces being positioned symmetrically and directed in the opposite direction to each other.

3. A device according to claim 2, characterised in that the mirror faces (5, 7) adjacent the optical axis of the camera are so positioned that one of their sides edges meet.

4. A device according to claim 2, characterised in that the mirror faces (5, 7) adjacent to the optical axis of the camera are offset relative to each other along the optical axis.

5. A device according to claim 1, characterised in that the mirror surfaces (5. 6, 7, 8) in each pair are positioned obliquely relative to each other.

6. A device according to claim 1, characterised in that the imaging is carried out when the container (3) is on a conveyor (4) provided in a reverse vending machine for beverage containers.

7. A device claim 1, characterised in that the processor comprises a comparator adapted to recognise, on the basis of the image selected by the processor, the respective areas along the longitudinal direction of the container (3) on comparison with a reference archive.
